(19) United States
(12) Patent Application Publication
(10) Pub. No.: US 2025/0213088 A1
(43) Pub. Date: Jul. 3, 2025

(54) APPARATUS FOR CLEANING SURFACES USING THE BERNOULLI PRINCIPLE

(71) Applicant: Irving Hoffman, Smyrna, GA (US)

(72) Inventor: Irving Hoffman, Smyrna, GA (US)

(21) Appl. No.: 18/397,254

(22) Filed: Dec. 27, 2023

(51) Int. Cl. A47L 11/38; A47L 11/40

(52) U.S. Cl. CPC A47L 11/38; A47L 11/4083; A47L 11/4088

(57) ABSTRACT

An apparatus for cleaning a surface includes a support having a cavity, a conduit, at least one cleaning element, and a skirting member. A pressurized cleaning fluid is controllably directed to the cavity. When the apparatus is applied to a surface, the skirting member forms a fluid flow region with a reduced cross-sectional area through which the cleaning fluid must travel, increasing the velocity of the fluid and reducing the pressure in the fluid flow region. With a reduced pressure now in the fluid flow region between a surface to be cleaned and the skirting member, a greater atmospheric pressure beyond the skirting member employs the Bernoulli principle to force the skirting member, attached to the support, against the surface to be cleaned.

### FIELD

The present subject matter is directed in general to a cleaning apparatus, and more particularly, to an apparatus for cleaning surfaces using the Bernoulli principle.

### BACKGROUND

Cleaning vertical or overhead surfaces can be very difficult, requiring the user to raise the apparatus for extended periods of time. A traffic control sign, for example, generally has dimensions and placement which make it difficult to press the cleaning head to the surface and to keep it there throughout the cleaning process.

Bernoulli's famous principle—the physical law well known in the field of fluid dynamics relating pressure, speed, and height—states that an increase in the speed of a fluid occurs simultaneously with a decrease in static pressure or the fluid's potential energy. This well-known principle, named after the Swiss mathematician and physicist Daniel Bernoulli, was published in 1738 in his book Hydrodynamica. Those in the field of fluid dynamics know that Bernoulli's principle can be derived from the principle of conservation of energy, which states, for steady flow, that the sum of all forms of energy in a fluid is the same at all points free of viscous forces. This requires that the sum of kinetic energy, potential energy, and internal energy remains constant. If a fluid flows out of a reservoir, the sum of all forms of energy is the same since, in a reservoir, the energy per unit volume (sum of pressure and gravitational potential) is the same everywhere. Bernoulli's principle can also be derived from Sir Isaac Newton's second Law of Motion. If a small volume of fluid is flowing horizontally from a first region of high pressure to a second region of low pressure, there is a pressure differential between the two regions, which provides more pressure behind than in front, resulting in a net force on the volume, accelerating a fluid along a streamline. If the fluid is flowing horizontally along a section of a streamline, its speed increases since fluid on that section has moved from a higher pressure region to a lower pressure region. Furthermore, if its speed decreases, that is because it has moved from the lower pressure region to the higher pressure region. Consequently, for a fluid flowing horizontally, its highest speed occurs where the pressure is lowest, and lowest speed occurs where pressure is highest. Bernoulli's principle is only applicable for isentropic flow, i.e., when effects of irreversible processes (i.e., turbulence) and non-adiabatic processes (such as thermal radiation) are small and can be neglected.

U.S. Pat. No. 4,029,351 to Apgar et al. discloses a Bernoulli pickup head that has a self-restoring anti-tilt improvement. The pickup head includes a central positive-pressure gas-coupled orifice and at least three auxiliary positive-pressure gas-coupled orifices disposed symmetrically about the central orifice. Gas flow from the central orifice effects the main lifting force and gas flow from the auxiliary orifices effects additional restoring torque to correct for wafer tilt if present. Integrity of a non-contacting relationship between the head and the wafer surface is enhanced, preserved, and very advantageous at lift off.

U.S. Pat. No. 4,419,704 to Radman et al. discloses a Bernoulli plate designed for juxtaposition to a rotating flexible magnetic disk rendered substantially rigid by a vacuum formed by the air between the plate and the disk being urged outwardly under the influence of centrifugal force. The plate is formed by coining a metal substrate and then electroplating the coined substrate so that sharp irregularities resulting from the coining operation are smoothed, while the surface is provided with a hard, wear-resistant coating.

U.S. Pat. No. 5,080,549 to Goodwin et al. discloses an apparatus operating under the Bernoulli principle and including a plate having a plurality of laterally oriented outlets and a central outlet for discharging gas in a predetermined pattern sufficient to develop a low-pressure environment to pick up a wafer while bathing the wafer in radially outflowing gases to prevent intrusion and deposition on the wafer of particulate matter in suspension.

U.S. Pat. No. 5,492,566 to Sumnitch discloses a support for disk-shaped articles using the Bernoulli principle. The support includes an annular nozzle disposed in a circular surface of the support. U.S. Pat. No. 7,908,902 to Levitsky et al. discloses a method of vapor sampling and its delivery to porous sensory element(s) employed in chemical detectors and/or sensors for vapor(s) identification and quantification. The sampling and delivery system comprises a flow cell in which a sensory membrane is placed parallel to the flow, while an additional flow normal to the membrane is introduced using the Bernoulli effect.

U.S. Pat. No. 8,613,474 to Goodman et al. discloses a frame forming a support adapted to support an adhering surface thereon, and a Bernoulli chuck surface coupled to the frame and adapted to support the substrate. The Bernoulli chuck surface is axially moveable relative to the support between first and second positions. In the first position, the substrate is coupled to the adhering surface, and the substrate is separated from the adhering surface with movement of the Bernoulli chuck from the first position to the second position, without contact between the substrate and the Bernoulli chuck surface.

U.S. Pat. No. 11,110,614 to Quast et al. discloses a gripping device having a Bernoulli gripping unit and a vacuum gripping unit. U.S. Pat. No. 11,284,994 to Huehn et al. discloses a Bernoulli gripper which includes a gripper body with a first cavity corresponding in shape to an optic zone of an ophthalmic lens and a first channel formed within the gripper body.

As can be seen, there is a need for a cleaning apparatus that adheres itself to a surface to be cleaned via Bernoulli's principle, reducing strain on the user when cleaning vertical and overhead surfaces.

### SUMMARY

In operation, the apparatus of the present subject matter can easily be designed so that a pressurized cleaning fluid can be controllably discharged and directed to a spacing between a preselected membrane and a surface, to produce a reduced cross-sectional area through which the cleaning fluid must travel for increasing a fluid velocity which, in turn, reduces the pressure of the fluid.

With a reduced pressure now in the fluid flow region between a surface to be cleaned and the membrane, a greater atmospheric pressure beyond the membrane forces the preselected membrane, fixed to the apparatus, to press the membrane towards such a surface, thereby holding the apparatus against the surface to be cleaned. An embodiment of the apparatus disclosed herein includes a washing or scrubbing head powered by pressurized water turning a brush fixed to a water turbine at an end of a light-weight wand delivering pressured water and, if needed, effective injected amounts of detergent.

Such a washing head can easily be designed so that an attached non-rotating membrane skirt causes discharged water to flow between the membrane and a surface to be cleaned. Sizes of this cleaning apparatus are easily scalable to suit flat and/or curved surfaces. A system comprising a fluid reservoir, a fluid pressurizer, and a fluid-delivery wand and/or discharge device can easily be mounted on a wheeled vehicle (e.g., on a pickup truck cargo area) or a wheeled pallet for easy movement, with the fluid pressurized by either a gasoline-powered water pressure washer or compressed air in an enclosed fluid reservoir. The source of power for the device is not particularly limited and may include any suitable source known in the art.

The cleaning fluid is not particularly limited and may be any fluid suitable for cleaning known in the art. For example, the fluid may be water, alcohol, a petroleum product, etc. The fluid may contain a detergent, surfactant, scrubbing aid, etc.

The surface to be cleaned is not particularly limited. Examples of suitable surfaces which may require cleaning include airplane wings and fuselage, a mural painting, a building side, directional signs, and traffic signs hanging from bridges.

The cleaning apparatus disclosed herein retains its position against a surface to be cleaned for a period of time without a disk-shaped article, nozzle, or compressed gas discussed in the prior art. Rather, the apparatus is drawn to, or pressed against, the surface by a pressure differential created by the high velocity of the discharged fluid between the non-rotating membrane and the surface.

These and other features, aspects and advantages of the present invention will become better understood with reference to the following drawings, description, and claims.

### BRIEF DESCRIPTION OF THE DRAWINGS

FIG. 1 is a sectional view of an apparatus according to an embodiment of the present subject matter.

FIG. 2A is an exploded view of an apparatus according to another embodiment of the present subject matter.

FIG. 2B is a perspective view thereof, shown in use.

FIG. 3A is a perspective view, depicting the apparatus of FIG. 1 in use.

FIG. 3B is a detailed elevational view thereof.

Throughout the drawing figures and the detailed description, similar alphanumeric references shall be used to refer to features of the present subject matter that are similar.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

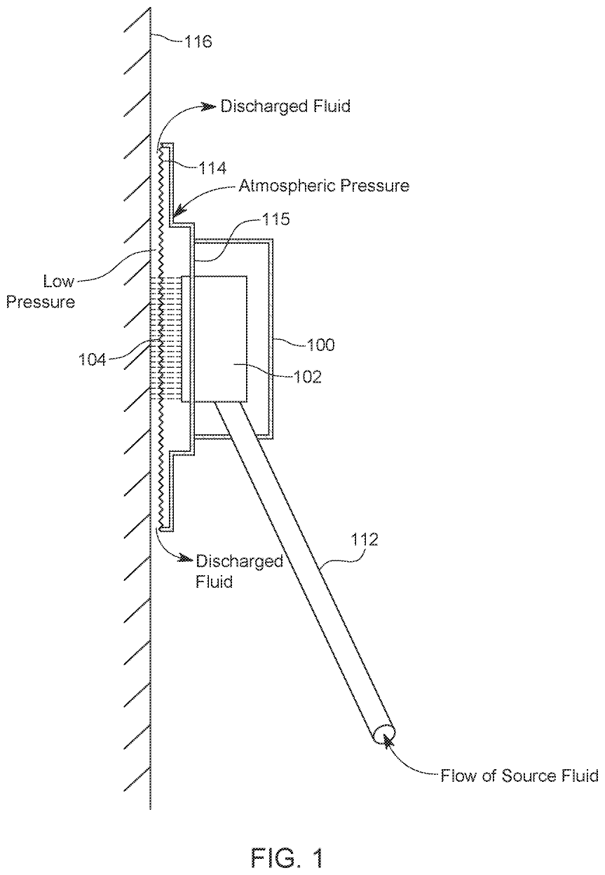

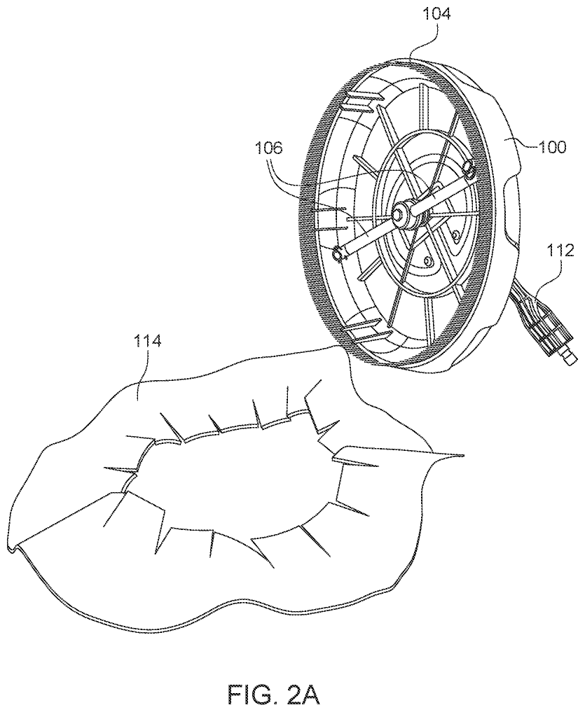

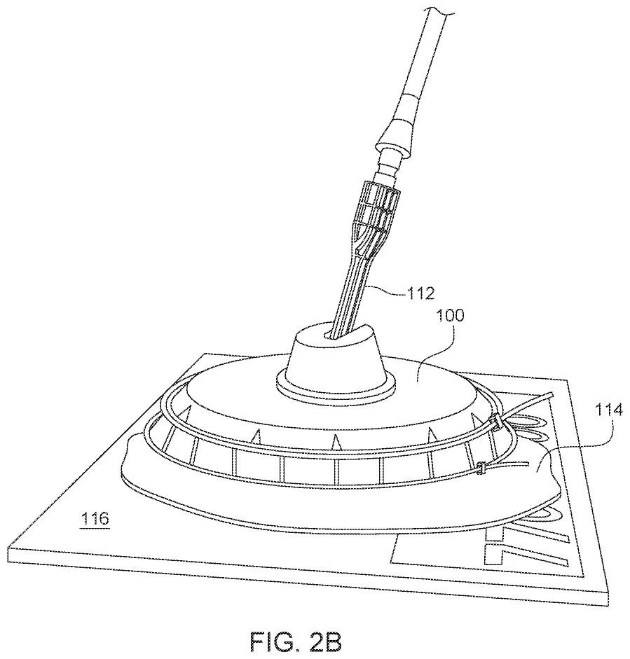

An apparatus used for cleaning surfaces, flat and/or curved, shall now be described in detail. As shown in FIG. 1, the apparatus includes a support 100 for a mechanical scrubber, such as a pad, or water motor 102 with bristles attached 104. The support 100 has a skirt member 114 secured to an exterior surface of the support 100 which draws the apparatus against a surface 116 to be cleaned by the Bernoulli principle. One embodiment of the skirt member 114 includes a flexible membrane 114, as seen, for example, in FIG. 2A. The apparatus further includes a cleaning element used to clean the flat or curved surface 116, such as a fluid motor or water turbine 102 and may include a plurality of bristles 104 secured to the water turbine 102.

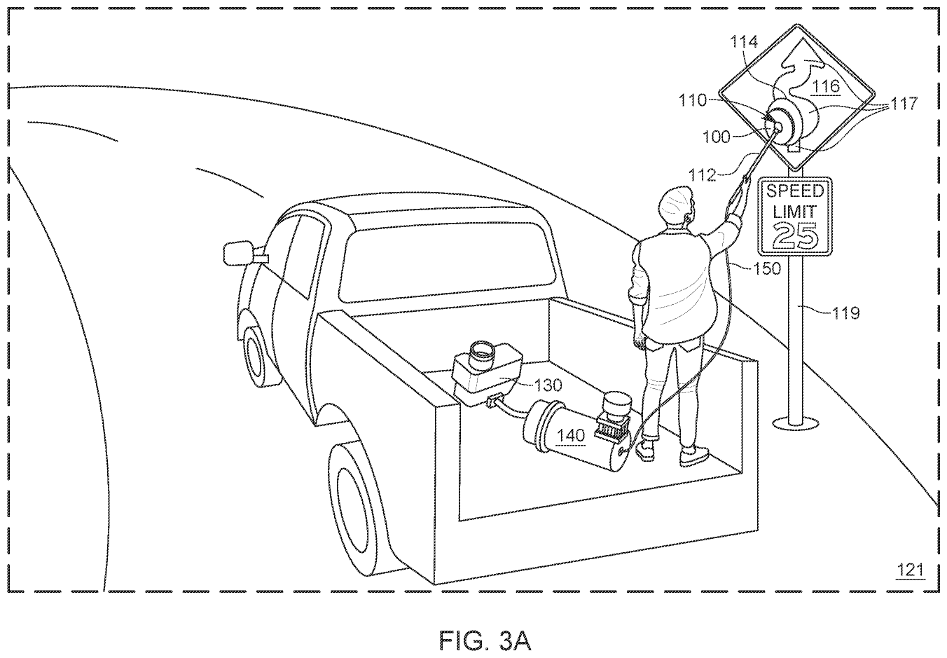

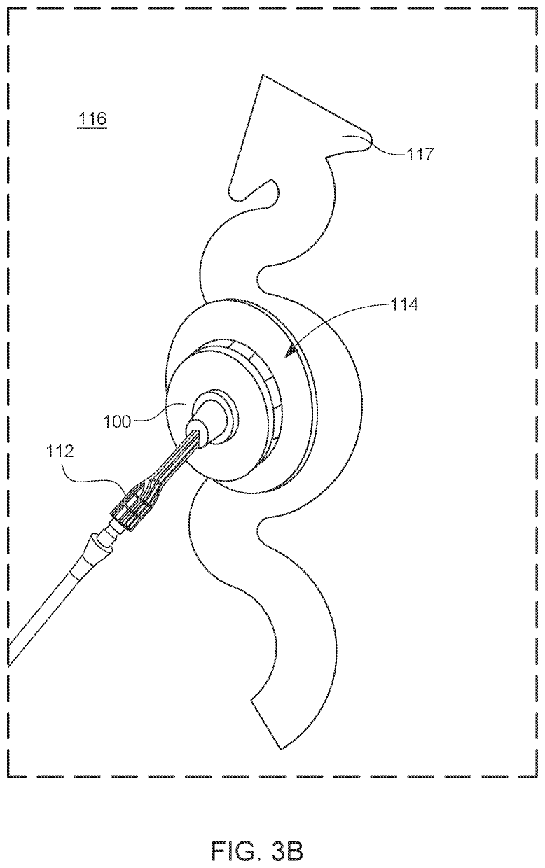

FIG. 3A illustrates the apparatus of the present subject matter with a swivel 110 joined in a fluid-tight manner to a cavity formed within the support 100. The apparatus of the present subject matter further includes a conduit 112 joined to the swivel 110 in a fluid-tight manner. The conduit 112 is adapted and configured to provide a cleaning fluid to the support 100. In some embodiments of the present subject matter, the swivel is variably orientable within the cavity, enabling the water turbine 102 to be parallel spaced from the surface 116, so that all of the plural bristles 115 are used to clean the surface 116.

In embodiments of the present subject matter, the cleaning fluid advantageously may include, but is not limited to, water and predetermined amounts of a preselected detergent.

The surface may be anything that requires cleaning, such as airplane wings and fuselage, a mural painting, a building side, directional signs, or traffic signs hanging from bridges. Without being limiting, the surface 116 shown in FIGS. 1, 2B, 3A, and 3B may include a directional icon 117 showing the curvature of the road ahead. The surface may be secured to a vertically oriented pole 119 fixed to the ground 121; see FIG. 3A.

As shown in FIG. 3A, the apparatus may include a fluid reservoir 130 sized for containing a predetermined amount of the cleaning fluid and means 150 adapted to provide the fluid from the reservoir 130 to the conduit 112. The apparatus may also include a compressor 140 operatively connected to the fluid reservoir 130 to pressurize the cleaning fluid. A person may use the apparatus by assembling the components if they have been stored separately, adding a cleaning fluid to the fluid reservoir 130, holding the support 100 against the surface 116 with the skirt member 114 contacting the surface 116, and activating the device, e.g., with a trigger handle (not shown), thereby delivering the cleaning fluid to the support 100, against the surface 116, and out through a region between the skirt member 114 and the surface 116. The apparatus is pressed against the surface 116 by ambient air pressure, easing the effort applied by the user to keep it in place during cleaning.

Described in detail in this patent specification is an apparatus used for cleaning surfaces, whereby the apparatus uses the Bernoulli principle. Included in the specification are details relating to associated drawing figures. While the present subject matter is described in connection with a current embodiment, the scope of the present subject matter is not to be limited to this embodiment. Indeed, many alternatives, changes, and/or modifications will become apparent to a person of ordinary skill in the art (“POSITA”) after this patent specification and its figures are reviewed. Therefore, all alternatives, changes, and modifications are to be viewed as forming a part of the present subject matter insofar as they fall within the spirit and the scope of the appended claims.

I claim:

1. An apparatus for cleaning a surface (116), comprising:
a support (100) having a cavity formed therein;
a conduit (112) joined to the support (100) in a swivelable, fluid-tight manner, wherein the conduit (112) is adapted and configured to provide a cleaning fluid to the cavity;
at least one cleaning element (102, 104, 106); and
a member (114) secured to an exterior surface of the support (100), wherein the member (114), when the apparatus is applied to the surface and is delivering cleaning fluid thereto, is operative to establish a pressure within a region between the member and the surface lower than ambient atmospheric pressure via the Bernoulli principle.

2. The apparatus of claim 1, wherein the cleaning fluid comprises water and a detergent in a predetermined proportion.

3. The apparatus of claim 1, wherein the member (114) comprises a flexible membrane (114) having a collar operative to secure the flexible membrane (114) to the support (100).

4. The apparatus of claim 1, wherein the at least one cleaning element (102, 104, 106) is selected from the group consisting of: a pad, a rotor, a fluid driven turbine (102), a plurality of bristles (104), and any combination thereof.

5. The apparatus of claim 1, including a fluid reservoir (130) sized to contain a predetermined amount of the cleaning fluid; a compressor (140) operatively connected to the fluid reservoir (130); and means (150) adapted to provide the fluid from the reservoir (130) to the conduit (112); wherein the compressor (140) is operative to pressurize the cleaning fluid conducted through the means (150).

6. The apparatus of claim 1, wherein the surface (116) is flat or curved.
